(19) United States
(12) Patent Application Publication
(10) Pub. No.: US 2019/0011697 A1
(43) Pub. Date: Jan. 10, 2019

(54) TRANSMISSION-TYPE SCREEN AND HEAD-UP DISPLAY

(71) Applicant: SHARP KABUSHIKI KAISHA, Sakai City, Osaka (JP)

(72) Inventors: NARU USUKURA, Sakai City (JP); TAKAFUMI SHIMATANI, Sakai City (JP)

(21) Appl. No.: 15/750,577

(22) PCT Filed: Aug. 2, 2016
(86) PCT No.: PCT/JP2016/072657

§ 371 Date: Feb. 6, 2018

(30) Foreign Application Priority Data
Aug. 7, 2015 (JP) 2015-157077

(51) Int. Cl. G02B 27/01; G02B 3/00

(52) U.S. Cl. CPC G02B 27/0101; G02B 2027/0118; G02B 2027/0145; G02B 3/0062

(57) ABSTRACT

A transmission-type screen (20) is a transmission-type screen for use in a head-up display (100), the transmission-type screen having a receiving surface to receive displaying light and an outgoing surface through which to emit a divergent light beam toward a combiner (40). The transmission-type screen (20) includes: a first optical element (21) which is disposed on the receiving surface side and which converges a light beam, the first optical element (21) having a first lens array (22) including a plurality of lenses (25) arranged with lens surfaces thereof being oriented toward the outgoing surface; and a second optical element (23) which is disposed on the outgoing surface side and which diverges a light beam, the second optical element (23) having a second lens array (24). In the first lens array, a numerical aperture NA of each lens satisfies the relationship NA=(r/2)/[f²+(r/2)²]^{1/2}≤0.13, where r is a diameter of each of the plurality of lenses and f is a focal length of each lens.

### TECHNICAL FIELD

The present invention relates to a transmission-type screen and a head-up display including the same.

### BACKGROUND ART

Head-up displays (hereinafter referred to as “HUD”) which display information in the field of view of a human have been used for assisting in piloting or driving, by displaying information on the windshield of a vehicle such as an aircraft or an automobile.

First, the construction of an HUD will be briefly described. A typical exemplary construction of a conventional HUD is shown in FIG. 11. An HUD typically includes a video source, a transmission-type screen, and a combiner. One type of HUD is a type that uses virtual image optics. According to this type, a light beam which has been emitted from the video source is converged by the transmission-type screen, which is a transparent object (e.g., glass), whereby a real image is formed (displayed). The transmission-type screen functions as a secondary light source which allows the converged light beam to go out toward the combiner. The combiner has the function of allowing a video image which was created at the transmission-type screen to be displayed in enlarged size at a distance, and also the function of displaying the video image as an overlay on the landscape. The combiner forms a virtual image which is based on the radiated light beam. As a result of this, through the combiner, a pilot or driver is able to check the video image together with the landscape.

Patent Document 1 discloses a transmission-type screen having first and second microlens arrays (hereinafter referred to as “MLA”) in which a plurality of microlenses (hereinafter referred to as “ML”), each microlens having the shape of a regular hexagon, are arranged. The second MLA is disposed at a position which is away from the first MLA by a distance that is longer than the focal length of the MLs. Specifically, it is stated that the two MLAs are preferably spaced apart by a distance which is not less than 1.5 times and not more than 3 times the focal length. Moreover, the direction along which the apices of the MLs in the first MLA are aligned is made different from the direction along which the apices of the MLs in the second MLA are aligned. With this construction, there is no need for alignment with respect to the interval between two MLAs, etc., whereby a transmission-type screen can be easily produced at low cost.

A structure in which two MLAs are stacked, commonly known as so-called “double microlens (DMLA)”, is applicable to transmission-type screens in which a laser light source is used as the video source. The transmission-type screen of Patent Document 1 also uses this DMLA.

### CITATION LIST

### Patent Literature

[Patent Document 1] Japanese Patent No. 4769912

### SUMMARY OF INVENTION

### Technical Problem

HUDs are expected to further improve with respect to various characteristics, in particular display quality. It would be possible to achieve high display quality from various standpoint; among others, since an HUD is also used at nighttime, displaying with a high contrast is particularly required. However, using a DMLA is likely to result in stray light, thus causing crosstalk and leading to the problem of lowered display quality (so-called contrast).

The present invention has been made in order to solve the aforementioned problem, and an objective thereof is to provide a transmission-type screen which can suppress decrease in display quality, and a head-up display including the same.

### Solution to Problem

A transmission-type screen according to an embodiment of the present invention is a transmission-type screen for use in a head-up display, the transmission-type screen having a receiving surface to receive displaying light and an outgoing surface through which to emit a divergent light beam toward a combiner, the transmission-type screen comprising: a first optical element which is disposed on the receiving surface side and which converges a light beam, the first optical element having a first lens array including a plurality of lenses arranged with lens surfaces thereof being oriented toward the outgoing surface; and a second optical element which is disposed on the outgoing surface side and which diverges a light beam, the second optical element having a second lens array, wherein, in the first lens array, a numerical aperture NA of each lens satisfies the relationship NA=(r/2)/[f²+(r/2)²]^{1/2}≤0.13, where r is a diameter of each of the plurality of lenses and f is a focal length of each lens.

In one embodiment, it is preferable that the second lens array is disposed in a position which is at a distance D from the first lens array, the distance D satisfying the relationship D=2 f.

In one embodiment, each of the first and second lens arrays may be a microlens array in which a plurality of microlenses are arranged, or a lenticular lens in which a plurality of cylindrical lenses are arranged.

In one embodiment, the first and second lens arrays may be microlens arrays in which a plurality of microlenses are arranged.

In one embodiment, the first lens array may be a microlens array in which a plurality of microlenses are arranged, and the lens surface of each of the plurality of microlenses may have a flat plane in a center of the lens surface, the flat plane being perpendicular to an optical axis.

In one embodiment, the first lens array may be a microlens array in which a plurality of microlenses are arranged, and the lens surface of each of the plurality of microlenses may have a shape that is characterized by using a negative conic constant.

In one embodiment, the first lens array may be a microlens array in which a plurality of microlenses are arranged, the plurality of microlenses being formed as an integral piece, and the microlens array may include a plurality of convex surfaces between two adjacent microlenses, the plurality of convex surfaces being oriented toward the receiving surface.

In one embodiment, it is preferable that the plurality of microlenses of the first optical element are arranged by hexagonal close packing.

In one embodiment, at least one of the first and second lens arrays may include a microlens array in which a plurality of microlenses are arranged, each of the plurality of microlenses having a shape which is a rectangle as viewed from the receiving surface side or the outgoing surface side. The microlenses typically have square shapes.

In one embodiment, the second optical element may include a first lenticular lens having a plurality of cylindrical lenses arranged along a first direction and a second lenticular lens having a plurality of cylindrical lenses arranged along a second direction which intersects the first direction.

In one embodiment, a lens surface of the first lenticular lens may be oriented toward the receiving surface, and a lens surface of the second lenticular lens may be oriented toward the outgoing surface.

In one embodiment, a lens surface of the first lenticular lens may be oriented toward the outgoing surface, and a lens surface of the second lenticular lens may be oriented toward the receiving surface so as to oppose the lens surface of the first lenticular lens.

In one embodiment, lens surfaces of the first and second lenticular lenses may be oriented in a same direction toward the receiving surface or the outgoing surface.

In one embodiment, it is preferable that the first direction and the second direction are orthogonal to each other.

In one embodiment, the first lenticular lens and the second lenticular lens may be formed as an integral piece.

A head-up display according to an embodiment of the present invention comprises: a video source to emit displaying light; any one of the aforementioned transmission-type screens; and a combiner.

In one embodiment, the video source may be a laser light source.

### Advantageous Effects of Invention

According to an embodiment of the present invention, there is provided a transmission-type screen which can suppress decrease in display quality, and a head-up display including the same.

### BRIEF DESCRIPTION OF DRAWINGS

FIG. 1 A schematic diagram showing the block construction of a head-up display 100 according to a first embodiment.

FIG. 2A A schematic cross-sectional view showing the structure of a transmission-type screen 20 according to the first embodiment.

FIG. 2B A schematic diagram showing the shape of an MLA 22 as viewed from the outgoing surface side, and the shape of the MLA 24 as viewed from the receiving surface side, of the transmission-type screen 20.

FIG. 2C A schematic diagram showing a lens diameter r and a lens pitch p of MLs 25.

FIG. 2D A schematic diagram showing a lens diameter r and a lens pitch p of MLs 25.

FIG. 2E A schematic diagram showing a lens diameter r and a lens pitch p of MLs 25.

FIG. 3A A schematic diagram showing how stray light a may occur with a conventional transmission-type screen having a DMLA.

FIG. 3B A schematic diagram how stray light a may occur with the transmission-type screen 20.

FIG. 4 (a) is a schematic diagram showing a luminance distribution of a light beam which is radiated onto the transmission-type screen 20 in the manner of a step function; (b) is a schematic diagram showing a luminance distribution of a divergent light beam from the transmission-type screen; and (c) is a graph showing a luminance distribution that changes in accordance with the numerical aperture NA.

FIG. 5 A graph showing a relationship between NA and crosstalk width.

FIG. 6A A cross-sectional schematic view of a spherical lens of an ML 25.

FIG. 6B A cross-sectional schematic view of an ML 25 having a flat plane near the center of the lens surface, the flat plane being perpendicular to the optical axis.

FIG. 6C A cross-sectional schematic view of an ML 25 having a lens surface that is characterized by using a negative conic constant.

FIG. 6D A cross-sectional schematic view showing parts of two adjacent MLs 25 in an MLA 22 with a plurality of convex surfaces C between two adjacent MLs 25, such convex surfaces C being oriented toward the receiving surface.

FIG. 7A A schematic cross-sectional view showing the structure of a transmission-type screen 20A according to a variant of the first embodiment.

FIG. 7B A schematic diagram showing the shape of a lenticular lens 29A as viewed from the outgoing surface side, and the shape of a lenticular lens 29B as viewed from the receiving surface side, of the transmission-type screen 20A.

FIG. 8A A schematic cross-sectional view showing the structure of a transmission-type screen 20B according to a second embodiment.

FIG. 8B A schematic diagram showing the shape of an MLA 22 as viewed from the outgoing surface side, and the shape of an MLA 24 as viewed from the receiving surface side, of the transmission-type screen 20B.

FIG. 9A A schematic cross-sectional view showing the structure of a transmission-type screen 20C according to a third embodiment.

FIG. 9B A schematic diagram showing the shape of an MLA 22 as viewed from the outgoing surface side, the shape of a lenticular lens 26A as viewed from the receiving surface side, and the shape of a lenticular lens 26B as viewed from the outgoing surface side, of the transmission-type screen 20C.

FIG. 10A A schematic cross-sectional view showing the structure of a transmission-type screen 20D according to a variant of the third embodiment.

FIG. 10B A schematic diagram showing the shape of an MLA 22 as viewed from the outgoing surface side, the shape of a lenticular lens 26A as viewed from the outgoing surface side, and the shape of a lenticular lens 26B as viewed from the receiving surface side, of the transmission-type screen 20D.

FIG. 11 A schematic diagram showing the block construction of a conventional head-up display.

### DESCRIPTION OF EMBODIMENTS

Through their studies, the inventors have arrived at: a novel transmission-type screen which includes at least one lens array at each of the receiving surface side and the outgoing surface side, such that the lenses in the lens array on the receiving surface side have a focal length, a lens diameter, and a numerical aperture which satisfy a predetermined relationship; and an HUD including the same.

A transmission-type screen according to an embodiment of the present invention has a DMLA structure as described above, including: a first optical element which is disposed on the receiving surface side and which converges a light beam, the first optical element having a first lens array including a plurality of lenses arranged with their lens surfaces being oriented toward the outgoing surface; and a second optical element which is disposed on the outgoing surface side and which diverges a light beam, the second optical element having a second lens array. In the first lens array, a numerical aperture NA of each lens satisfies the relationship NA=(r/2)/[f²+(r/2)²]^{1/2}≤0.13, where r is a diameter of each of the plurality of lenses and f is a focal length of each lens. With this transmission-type screen, decrease in contrast, as occurring due to stray light, can be effectively suppressed.

Hereinafter, with reference to the attached drawings, a transmission-type screen and a head-up display including the same according to an embodiment of the present invention will be described. In the following description, identical or similar constituent elements are denoted by the same reference numeral. Note that a transmission-type screen and a head-up display according to an embodiment of the present invention are not limited to what is illustrated below.

### First Embodiment

With reference to FIG. 1 through FIG. 6D, the structure and function of a transmission-type screen 20 and a head-up display including the same 100 according to the present embodiment will be described.

FIG. 1 schematically shows the construction of the head-up display 100 according to the present embodiment.

The head-up display 100 includes a video source 10, a transmission-type screen 20, a field lens 30, and a combiner 40. The head-up display 100 may further include a mirror or the like to alter the optical path of the light beam. For example, such a mirror may be disposed between the transmission-type screen 20 and the combiner 40. Note that the field lens 30 may not be included, as will be described later.

A light beam which has been emitted from the video source 10 is converged by the transmission-type screen 20, whereby a real image is formed. The transmission-type screen 20 functions as a secondary light source which allows the converged light beam to go out toward the combiner 40. The combiner 40 forms a virtual image which is based on the radiated light beam. As a result of this, through the combiner 40, a pilot or driver is able to check the video image together with the landscape.

Details of each constituent element of the head-up display 100 will be described.

The video source 10 may be any one of a broad variety of known devices to render a video image. The video source 10 is constructed so as to emit displaying light toward the transmission-type screen 20. For example, as methods of rendering, methods which utilize LCOS (Liquid Crystal On Silicon), LCD (Liquid Crystal Display), or DLP (Digital Light Processing), methods which utilize a laser projector, and the like are known.

In the LCOS or LCD-based method, mainly, LED (Light Emitting Diode) light sources of three primary colors (R, G and B) are used together with an LCOS or LCD. In the DLP-based method, mainly, LED light sources of three primary colors and a DMD (Digital Micromirror Device) are used. In these methods, each LED light source irradiates the entire LCD, LCOS, or DMD with a light beam, while any unwanted light that does not contribute to the video image is cut off by the LCD, LCOS, or DMD. Also known is a video source which combines laser light sources (RGB lasers) of three primary colors with an LCOS, LCD, or DLP.

On the other hand, in a method which utilizes a laser projector, mainly, laser light sources of three primary colors and MEMS (Micro Electro Mechanical Systems) mirrors are used. Moreover, these elements may also be combined with a screen such as a diffuser or an MLA, or a micromirror array, etc. Under this method, the video image in only the targeted displaying region is rendered by raster scan method.

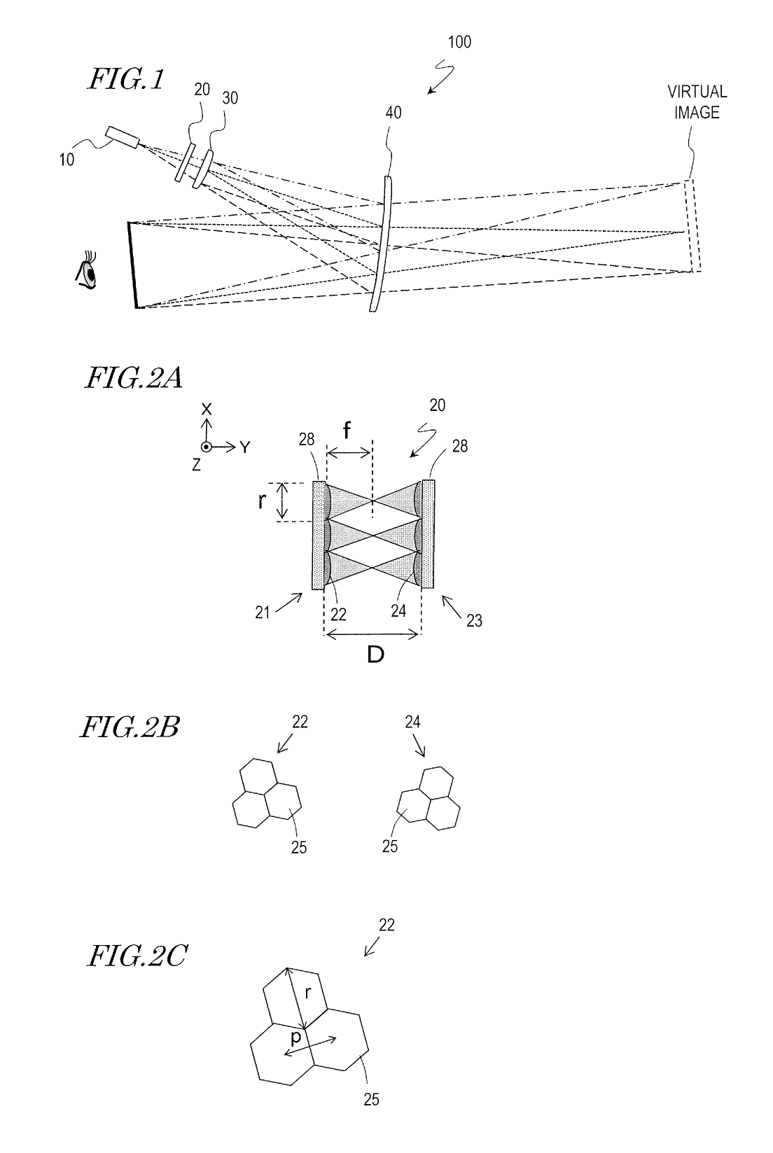

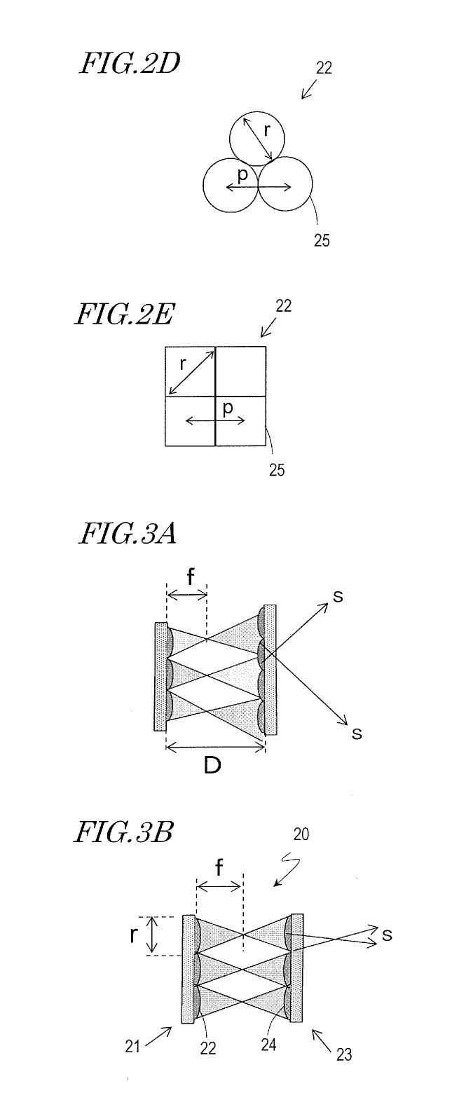

FIG. 2A is a schematic cross-sectional view showing the structure of the transmission-type screen 20. FIG. 2B schematically shows the shape of an MLA 22 as viewed from the outgoing surface side, and the shape of the MLA 24 as viewed from the receiving surface side, of the transmission-type screen 20. In FIG. 2A, the side on which a first optical element 21 is disposed defines the receiving surface side, whereas the side on which a second optical element 23 is disposed defines the outgoing surface side.

The transmission-type screen 20 includes the first optical element 21 and the second optical element 23. The first optical element 21, which has an MLA 22 of a plurality of MLs 25 arranged with their lens surfaces being oriented toward the outgoing surface, converges a light beam. The second optical element 23, which has an MLA 24 of a plurality of MLs 25 arranged with their lens surfaces being oriented toward the receiving surface, diverges a light beam. In the present specification, a “lens surface” refers to a convex surface or a concave surface of a lens.

The lens surface of the MLA 22 is oriented toward the outgoing surface. The MLA 22 converges displaying light from the video source 10 to form a real image between the MLA 22 and the MLA 24.

As shown in FIG. 2B, as viewed from the receiving surface side or the outgoing surface side, the shape of each ML 25 in the MLAs 22 and 24 is typically a regular hexagon, with the plurality of MLs 25 typically being arranged by hexagonal close packing in the XZ plane shown in FIG. 2A. Other than the aforementioned shape, the shape of each ML 25 may be a circle or a rectangle, for example. However, from the standpoint of improving the efficiency of light utilization, the shape of each ML 25 is preferably a regular hexagon.

The MLA 24 of the second optical element 23 is disposed in a position which is at a distance D from the MLA 22 along the Y axis direction shown in FIG. 2A, the distance D being longer than the focal length f of the lenses of the MLA 22 of the first optical element 21. Herein, the distance D is a distance between the faces (the XZ plane) of the MLAs 22 and 24 having the plurality of MLs 25 arranged thereon. As shown in FIG. 2A, the plurality of MLs 25 may be arranged on a transparent substrate 28 (e.g., a glass substrate), for example. In that case, the distance D is a distance between the face of the transparent substrate 28 of the MLA 22 on the outgoing surface side and the face of the transparent substrate 28 of the MLA 24 on the receiving surface side that is opposed to this face. The distance D is preferably in the range from e.g. not less than 1.5 f and not more than 3.0 f, and more preferably satisfies the relationship D=2 f from a standpoint which will be described below.

When the relationship D=2 f is satisfied, the spread of the light beam on the MLs 25 of the MLA 22 and the spread of the light beam on the MLs 25 of the MLA 24 become substantially equal, thus hindering deterioration in resolution. Moreover, even when a laser light source is used as the video source 10, excessive bright dot pixels (unevenness in luminance), which may be caused by diffraction of laser light, are less likely to occur.

FIG. 2C through FIG. 2E are referred to. FIG. 2C shows a lens diameter r and a lens pitch p of regular hexagonal MLs 25. FIG. 2D shows a lens diameter r and a lens pitch p of circular MLs 25. FIG. 2E shows a lens diameter r and a lens pitch p of square MLs 25. In the present specification, a distance which is twice as large as the distance from the center of an ML 25 to the farthest point in the same ML 25 is denoted as “r”. In the case where the shape of an ML 25 is a rectangle or a regular polygon, r is equal to the diameter of the circumcircle of the ML 25, and corresponds to the so-called lens diameter. The distance between the centers of two adjacent lenses is denoted as “p”.

The relationship between the lens diameter r and the lens pitch p will be described. As a typical example, in the case where the plurality of MLs 25 are arranged by hexagonal close packing, the lens diameter r and the lens pitch p satisfy the relationship p=(¾)^{1/2}r. Specifically, in the construction shown in FIG. 2C, p=(¾)^{1/2}r is satisfied. Similarly, in the construction shown in FIG. 2D, p=r is satisfied; and in the construction shown in FIG. 2E, p=r/(2)^{1/2} is satisfied.

A numerical aperture NA of the MLs 25 of the MLA 22 that are on the receiving surface side of the transmission-type screen 20 can be expressed by eq. (1) below, by using the lens diameter r and the focal length f.

NA=(r/2)/[f²+(r/2)²]^{1/2} eq. (1)

In the present embodiment, in order to suppress decrease in contrast, the MLA 22 of the first optical element 21 is chosen so that its NA, r, and f satisfy eq. (2) below.

NA=(r/2)/[f²+(r/2)²]^{1/2}≤0.13 eq. (2)

As can be seen from eq. (2), NA is equal to or smaller than 0.13, and, by using NA, the focal length f of the lens when its lens diameter is r can be determined from eq. (2). The two MLAs are opposed to each other so as to be spaced apart by a distance D which is determined based on this focal length f.

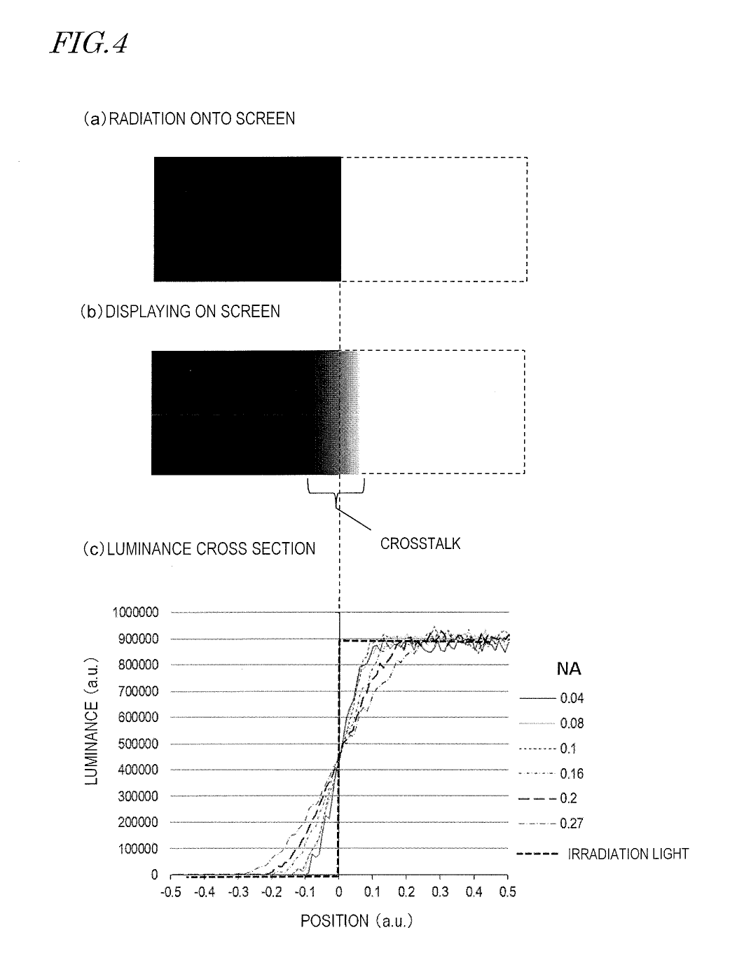

With reference to FIG. 3A, FIG. 3B, and FIG. 4, the mechanism by which contrast is decreased by stray light s will be described. FIG. 3A schematically shows how stray light s may occur with a conventional transmission-type screen having a DMLA, and FIG. 3B schematically shows how stray light s may occur with the transmission-type screen 20 according to the present embodiment.

The above-described conventional transmission-type screen provides an advantage in that alignment between the two layers of MLA is unnecessary. However, since a structure which does not require alignment (which hereinafter may be referred to as an “alignment-free structure”) is adopted, during ray tracing it is impossible to predict at which position of an ML on the outgoing surface side a ray that is incident on an ML on the receiving surface side will arrive. Specifically, as shown in FIG. 3A, a light beam which is converged by a given ML on the receiving surface side may spread over two adjacent MLs on the outgoing surface side, for example. The reason is that, in an alignment-free structure, one-to-one correspondence does not exist between the MLA on the receiving surface side and the MLA on the outgoing surface side. In such a structure, it is difficult to perfectly control a light beam which is transmitted through the DMLA.

Stray light may occur depending on the incident angle of light which is incident on the MLA on the outgoing surface side. For example, as shown in FIG. 3A, stray light a that deviates greatly from the intended optical path is likely to occur because of the MLA on the outgoing surface side. This stray light s causes crosstalk, thereby lowering contrast. Thus, stray light s can be regarded as one of the factors that may lower contrast.

A regular arrangement of MLs 25 would be easily visually recognized as a pattern by a driver or the like. In order to account for this, the transmission-type screen 20 according to the present embodiment adopts two layers of MLA that lack one-to-one correspondence (i.e., an alignment-free structure). However, unlike in the conventional structure, as will be described in detail below, decrease in contrast due to stray light s can be suppressed according to the present embodiment.

As has been described above, since an HUD is also used at nighttime, it faces the problem as to how high its contrast can be. Through vigorous studies by the inventors, it has been found that the focal length f of the lenses of the MLA 22 on the receiving surface side affects stray light s, and that the degree of deviation of stray light s from the intended optical path may differ depending on the magnitude of the focal length f. While Patent Document 1 proposes how much interval should separate two MLAs, it fails to mention any optimum focal length for the lenses used in the MLAs.

As the stray light a deviates more from the intended optical path, an increase in crosstalk results, which affects contrast. Paying attention to the numerical aperture NA of the lenses, the inventors have further found that the numerical aperture NA of the lenses affects the occurrence of stray light s even more than does the focal length f.

FIG. 4(a) schematically shows a luminance distribution of a light beam which is radiated onto the transmission-type screen 20 in the manner of a step function; FIG. 4(b) schematically shows a luminance distribution of a divergent light beam from the transmission-type screen; and FIG. 4(c) shows a luminance distribution that changes in accordance with the numerical aperture NA. In FIG. 4(c), the horizontal axis represents relative position (coordinate) along the z axis direction shown in FIG. 2A with respect to a boundary in steps (i.e., a boundary between a high luminance region and a low luminance region), and the vertical axis represents magnitude of luminance.

In the present specification, along the z axis direction, an interval between a first position at which a luminance value that is 90% of the maximum value of luminance (which in FIG. 4(c) is 900000 [a.u.]) exists and a second position at which a luminance value which is 10% of the maximum value exists is defined as a crosstalk width. As the crosstalk increases, the crosstalk width becomes broader; as the crosstalk decreases, the crosstalk width becomes narrower.

As shown in FIG. 4(b), a crosstalk occurring near a boundary between steps lowers the contrast in the vicinity of the boundary. The reason is that a low-luminance light beam which has deviated from the intended optical path arrived as stray light a at a region irradiated by a high-luminance light beam in the vicinity of the boundary, and that a high-luminance light beam which has deviated from the intended optical path arrived as stray light a at a region irradiated by a low-luminance light beam in the vicinity of the boundary.

As shown in FIG. 4(c), when the lens NA is greater than the threshold value, i.e., 0.13, a smaller NA makes the crosstalk width relatively small. This indicates that, as NA becomes smaller, the degree by which stray light s deviates from the intended optical path becomes relatively small.

When NA is equal to or smaller than 0.13, the crosstalk width is substantially constant, irrespective of NA. This indicates that, when NA is equal to or smaller than 0.13, there is no difference in the degree by which stray light a deviates from the intended optical path. The reason for setting the threshold value for the lens NA to 0.13 is explained below.

FIG. 5 is a graph showing a relationship between NA and crosstalk width. The horizontal axis represents NA, and the vertical axis represents crosstalk width [a.u.]. It can be seen that NA=0.13 provides separation: when NA is equal to or smaller than 0.13, the crosstalk width remains substantially constant without changing; when NA exceeds 0.13, the crosstalk width rapidly increases with an increase in NA. Thus, when NA is equal to or smaller than 0.13, the crosstalk width can be reduced.

The above study results produced a finding that it is preferable the NA of the lenses of the MLA 22 is equal to or smaller than 0.13, i.e., that it satisfies eq. (2) above.

As shown in FIG. 3B, when the NA of the lenses of the MLA 22 is equal to or smaller than 0.13, the degree by which stray light s deviates from the intended optical path can be made much smaller than conventional. Since it is less likely for the stray light s to deviate from the intended optical path, the crosstalk width can be reduced. In other words, crosstalk is suppressed. Consequently, decrease in contrast can be effectively suppressed.

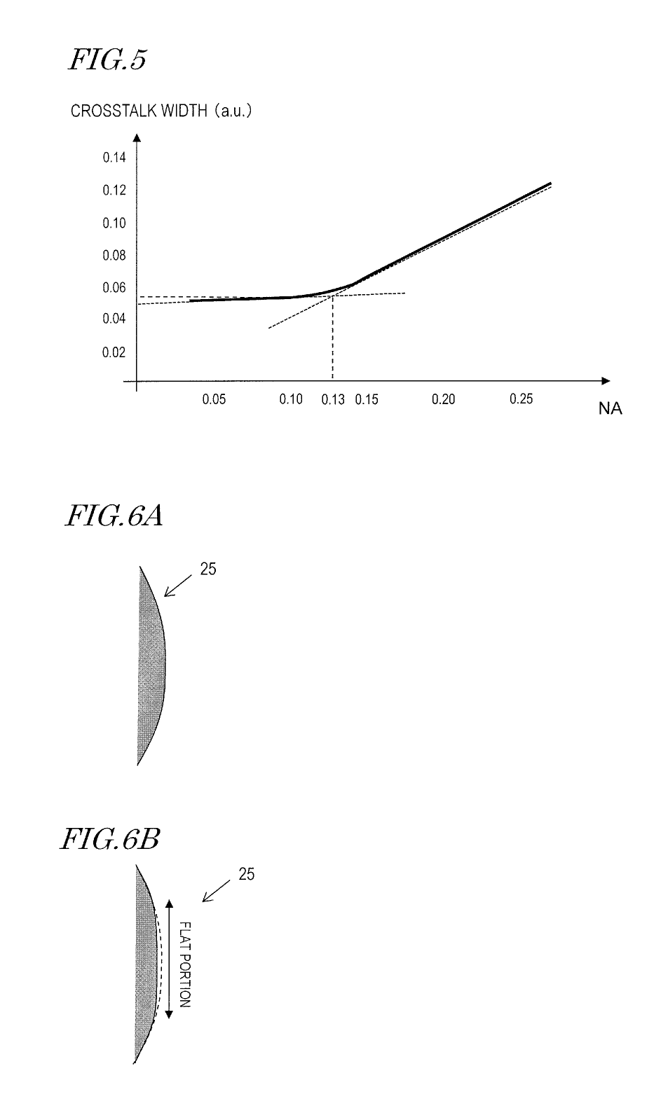

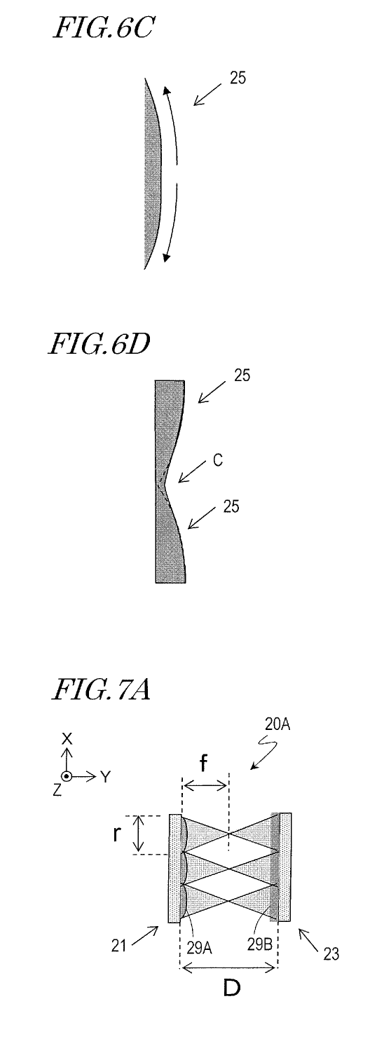

With reference to FIG. 6A through FIG. 6D, variations for the shape of the lens surface of the MLA 22 will be described.

FIG. 6A schematically shows a cross section of a spherical lens of an ML 25. FIG. 6B schematically shows a cross section of an ML 25 having a flat plane near the center of the lens surface, the flat plane being perpendicular to the optical axis. FIG. 6C schematically shows a cross section of an ML 25 having a lens surface that is characterized by using a negative conic constant. FIG. 6D schematically shows a cross section of parts of two adjacent MLs 25 in an MLA 22 with a plurality of convex surfaces C between two adjacent MLs 25, such convex surfaces C being oriented toward the receiving surface.

Typically, the shape of an ML 25 is a spherical surface as shown in FIG. 6A. However, in order to suppress decrease in contrast more effectively, MLs 25 as illustrated below may be used.

As shown in FIG. 6B, the ML 25 may have a flat plane in the center of the lens surface. As shown in FIG. 6C, the ML 25 may include a lens surface of a shape that is characterized by using a negative conic constant. A lens surface so characterized has a greater lens curvature toward the center of the lens surface, and a gradually decreasing curvature away from the center toward the outside (in the directions of arrows in FIG. 6C). As shown in FIG. 6D, between two adjacent MLs 25, a convex surface C which is oriented toward the receiving surface, i.e., opposite to the outgoing surface. In that case, the MLA 22 includes a plurality of MLs 25 which are formed as an integral piece.

As the angle of the lens surface of the ML 25 with respect to the face having the plurality of MLs 25 arranged thereon (e.g., the plane of the transparent substrate 28) increases, stray light s becomes more likely to occur. For example, when an ML 25 with a lens surface which includes a flat plane as shown in FIG. 6B is used, the flat plane will be substantially parallel to the plane of the transparent substrate 28, so that the flat plane (lens surface) will have essentially no angle with respect to the transparent substrate 28. Therefore, the crosstalk width can be effectively reduced. In other words, crosstalk is suppressed. Similar effects can also be obtained by using MLs 25 of other shapes as shown in FIG. 6C and FIG. 6D.

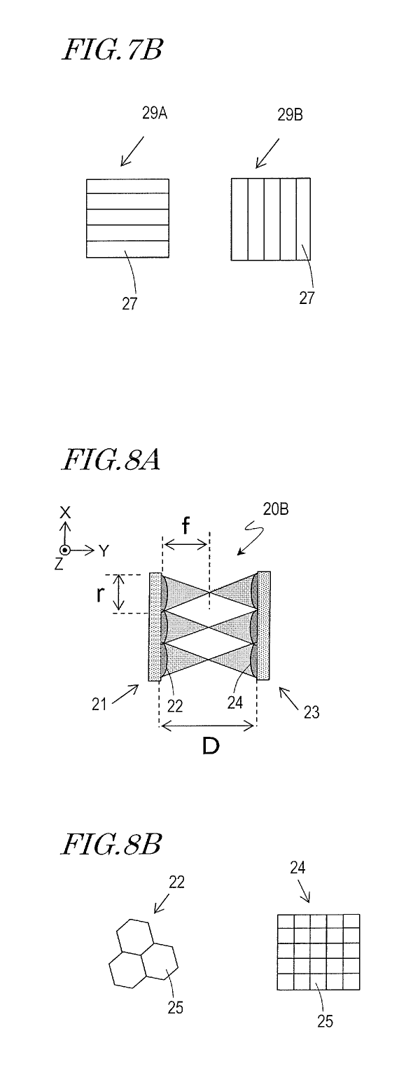

With reference to FIG. 7A and FIG. 7B, a transmission-type screen 20A according to a variant of the present embodiment will be described.

FIG. 7A is a schematic cross-sectional view showing the structure of the transmission-type screen 20A. FIG. 7B schematically shows the shape of a lenticular lens 29A as viewed from the outgoing surface side, and the shape of a lenticular lens 29B as viewed from the receiving surface side, of the transmission-type screen 20A.

The first optical element 21, which includes a lenticular lens 29A having a plurality of cylindrical lenses 27 arranged with their lens surfaces being oriented toward the outgoing surface, converges a light beam. The second optical element 23, which includes a lenticular lens 29B having a plurality of cylindrical lenses 27 arranged with their lens surfaces being oriented toward the receiving surface, diverges a light beam. Note that the lens surfaces of the lenticular lenses 29A and 29B may be oriented in the same direction toward the outgoing surface, or oriented in the same direction toward the receiving surface.

As shown in FIG. 7B, in the lenticular lens 29A, the plurality of cylindrical lenses 27 are arranged along a first direction (i.e., the X axis direction in FIG. 7A); in the lenticular lens 29B, the plurality of cylindrical lenses 27 are arranged along a second direction (i.e., the z axis direction in FIG. 7A) which intersects the first direction. From the standpoint of improving the efficiency of light utilization, it is preferable that the first direction and the second direction are orthogonal to each other. Moreover, the directions in which the plurality of cylindrical lenses 27 are arranged may be reversed between the lenticular lenses 29A and 29B.

In this variant, the cylindrical lenses 27 in the lenticular lens 29A on the receiving surface side have a numerical aperture NA that satisfies eq. (2) above. Moreover, as shown in FIG. 7A, the distance D is equal to the interval between the face of the lenticular lens 29A on which the plurality of cylindrical lenses 27 are arranged and the face of the lenticular lens 29B on which the plurality of cylindrical lenses 27 are arranged.

According to this variant, the light beam distribution can be controlled so that a divergent light beam having a cross-sectional shape which is a substantial rectangle is radiated toward the combiner 40.

It suffices if each of the first optical element 21 and the second optical element 23 according to an embodiment of the present invention includes at least one of a lenticular lens and an MLA. Therefore, without being limited to the above-described embodiment and its variant, the first optical element 21 may include a lenticular lens while the second optical element 23 may include an MLA, or, the first optical element 21 may include an MLA while the second optical element 23 may include a lenticular lens.

FIG. 1 is referred to again. The field lens 30 is disposed between the transmission-type screen 20 and the combiner 40, near the transmission-type screen 20. The field lens 30, which is composed of e.g. a convex lens, alters the direction of travel of a light beam which goes out from the transmission-type screen 20. Use of the field lens 30 allows the efficiency of light utilization to be further enhanced. The field lens 30 may be disposed between the video source 10 and the transmission-type screen 20, or may not be provided at all.

As the combiner 40, a half mirror is commonly used, for example; however, a hologram element or the like may also be used. The combiner 40 reflects a divergent light beam from the transmission-type screen 20 to form a virtual image of light. The combiner 40 allows a video image which is formed at the transmission-type screen 20 to be displayed in enlarged size at a distance, and furthermore displays the video image as an overlay on the landscape. As a result, through the combiner 40, a pilot or driver is able to check the video image together with the landscape. The size of the virtual image or the position at which the virtual image is formed may be changed in accordance with the curvature of the combiner 40.

According to the present embodiment, by using an MLA whose lens NA is equal to or smaller than 0.13, it becomes less likely for stray light a to deviate from the intended optical path. Thus, crosstalk is suppressed, whereby decrease in contrast can be effectively suppressed.

### Second Embodiment

A transmission-type screen 20B according to a second embodiment differs from the transmission-type screen 20 according to the first embodiment in that at least one of the first optical element 21 and the second optical element 23 includes an MLA of a so-called square lattice arrangement. Hereinafter, while omitting description of any aspects that are common to the transmission-type screen 20, mainly differences therefrom will be described.

FIG. 8A is a schematic cross-sectional view showing the structure of the transmission-type screen 20B. FIG. 8B schematically shows the shape of an MLA 22 as viewed from the outgoing surface side, and the shape of an MLA 24 as viewed from the receiving surface side, of the transmission-type screen 20B.

The first optical element 21, which includes the MLA 22 having a plurality of MLs 25 arranged with their lens surfaces being oriented toward the outgoing surface, converges a light beam. The second optical element 23, which includes the MLA 24 having a plurality of rectangular MLs 25 arranged in a square lattice shape with their lens surfaces being oriented toward the receiving surface, diverges a light beam.

The MLA 24 is a microlens array of a so-called square lattice arrangement. Conversely, it may be the first optical element 21 that includes an MLA 22 with a plurality of rectangular MLs 25 arranged in a square lattice shape. Typically, the rectangle is a square.

In the present embodiment, the MLs 25 of the MLA 22 on the receiving surface side have a numerical aperture NA that satisfies eq. (2) above. Moreover, as shown in FIG. 8A, the distance D is equal to the interval between the faces (the XZ plane) of the MLAs 22 and 24 on which the plurality of MLs 25 are arranged.

According to the present embodiment, it becomes easy to control light beam distribution. Specifically, from the outgoing surface of the transmission-type screen 20B, a divergent light beam having a cross-sectional shape which is a substantial rectangle is emitted. It is ensured that the light-irradiated region fits within the region of the combiner 40. This adequately limits the irradiation range of the divergent light beam, thus improving the efficiency of light utilization. Therefore, from the standpoint of improving the efficiency of light utilization, it is preferable that the shape of the MLs in the MLAs is a rectangle, rather than a circle.

### Third Embodiment

A transmission-type screen 20C according to a third embodiment differs from the transmission-type screen 20 according to the first embodiment in that the second optical element 23 includes two lenticular lenses. Hereinafter, while omitting description of any aspects that are common to the transmission-type screen 20, mainly differences therefrom will be described.

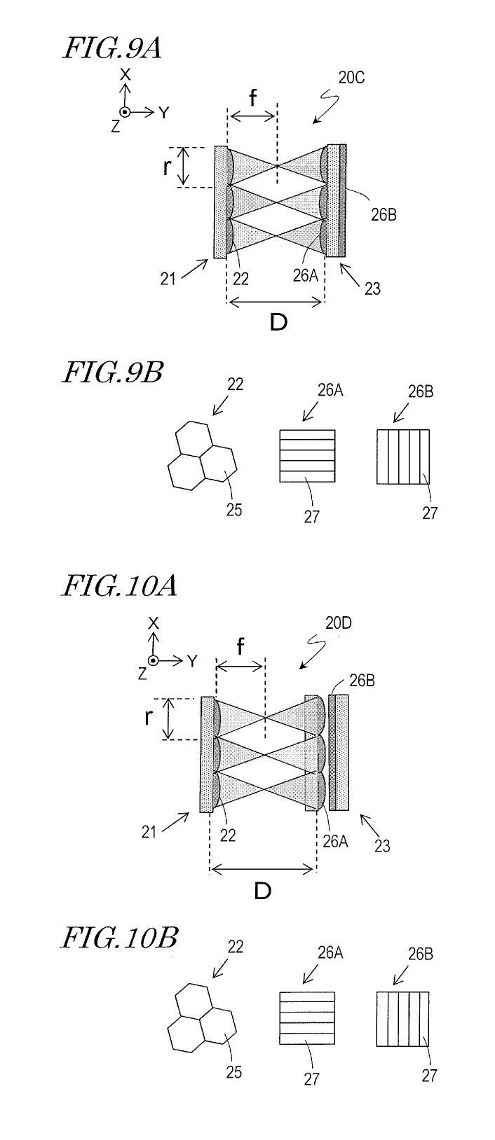

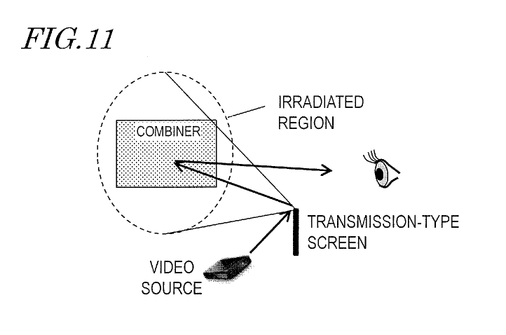

FIG. 9A is a schematic cross-sectional view showing the structure of the transmission-type screen 20C. FIG. 9B schematically shows the shape of an MLA 22 as viewed from the outgoing surface side, the shape of a lenticular lens 26A as viewed from the receiving surface side, and the shape of a lenticular lens 26B as viewed from the outgoing surface side, of the transmission-type screen 20C.

The first optical element 21, which includes an MLA 22 having a plurality of MLs 25 arranged with their lens surfaces being oriented toward the outgoing surface, converges a light beam. The second optical element 23 includes a first lenticular lens 26A having a plurality of cylindrical lenses 27 arranged along a first direction (i.e., the X axis direction in the figure) and a second lenticular lens 26B having a plurality of cylindrical lenses 27 arranged along a second direction (i.e., the z axis direction in the figure) which intersects the first direction.

The first lenticular lens 26A is disposed on the receiving surface side of the second optical element 23, and the second lenticular lens 26B is disposed on the outgoing surface side of the second optical element 23. The lens surface of the first lenticular lens 26A is oriented toward the receiving surface, and the lens surface of the second lenticular lens 26B is oriented toward the outgoing surface. The second optical element 23 diverges a light beam. From the standpoint of improving the efficiency of light utilization, it is preferable that the first direction and the second direction are orthogonal to each other.

In the present embodiment, the MLs 25 in the MLA 22 of the first optical element 21 have a numerical aperture NA that satisfies eq. (2) above. Moreover, as shown in FIG. 9A, the distance D is equal to the interval between the face of the MLA 22 on which the plurality of MLs 25 are arranged and the face of the first lenticular lens 26A on which the plurality of cylindrical lenses 27 are arranged.

With reference to FIG. 10A and FIG. 10B, a transmission-type screen 20D according to a variant of the present embodiment will be described.

FIG. 10A is a schematic cross-sectional view showing the structure of the transmission-type screen 20D. FIG. 10B schematically shows the shape of an MLA 22 as viewed from the outgoing surface side, the shape of a lenticular lens 26A as viewed from the outgoing surface side, and the shape of a lenticular lens 26B as viewed from the receiving surface side, of the transmission-type screen 20D.

The second optical element 23 includes a first lenticular lens 26A having a plurality of cylindrical lenses 27 arranged along a first direction (i.e., the X axis direction in the figure) and a second lenticular lens 26B having a plurality of cylindrical lenses 27 arranged along a second direction (i.e., the z axis direction in the figure) which intersects the first direction.

The first lenticular lens 26A is disposed on the receiving surface side of the second optical element 23, and the second lenticular lens 26B is disposed on the outgoing surface side of the second optical element 23. The two lenticular lens are opposed to each other, such that the lens surface of the first lenticular lens 26A is oriented toward the outgoing surface and that the lens surface of the second lenticular lens 26B is oriented toward the receiving surface. From the standpoint of improving the efficiency of light utilization, it is preferable that the first direction and the second direction are orthogonal to each other. Moreover, the two lenticular lenses can be formed as an integral piece.

This variant is not limited to the aforementioned implementation; the two lenticular lenses may be disposed so that the lens surfaces of the first lenticular lens 26 and the second lenticular lens 26B are oriented in the same direction toward the receiving surface or the outgoing surface.

In this variant, the MLs 25 of the MLA 22 on the receiving surface side have a numerical aperture NA that satisfies eq. (2) above. Moreover, as shown in FIG. 10A, the distance D is equal to the interval between the face of the MLA 22 on which the plurality of MLs 25 are arranged and the face of the first lenticular lens 26A on which the plurality of cylindrical lenses 27 are arranged.

In the present embodiment and its variant, so long as the lenticular lenses 26A and 26B are disposed so that the first direction and the second direction intersect each other, the first direction of the lenticular lens 26A and the second direction of the lenticular lens 26B may be reversed from the directions in which they are shown to be arranged in FIG. 9B or FIG. 10B.

According to the present embodiment and its variant, it becomes easy to control light beam distribution. Specifically, the lenticular lens 26B, which is disposed the closest to the outgoing surface side of the transmission-type screen 20C or 20D, mainly determines the light beam distribution. Therefore, by varying the lens pitch between two adjacent lenses in the lenticular lens 26B or the radius of curvature or central angle of the lenses, it is possible to change the aspect ratio of the irradiation shape of the divergent light beam, whose cross-sectional shape is a substantial rectangle. Thus, from the outgoing surface of the transmission-type screen 20C or 20D, a divergent light beam having a cross-sectional shape which is a substantial rectangle is emitted. For example, when the shape of the combiner 40 is a rectangle, it is ensured that the light-irradiated region fits within the region of the combiner 40. This adequately limits the irradiation range of the divergent light beam, thus improving the efficiency of light utilization.

Moreover, in the case where a laser light source is used as the video source 10, light beams which have been transmitted through MLAs or lenticular lenses may interfere with one another, thus resulting in speckles that are unique to laser in the regions irradiated by the light beams. These speckles will be visually recognized as a bright-dark pattern by the driver or the like, thereby significantly detracting from display quality.

According to the present embodiment and its variant, speckles can be effectively eliminated even when a laser light source is used as the video source 10, whereby high display quality is maintained. The transmission-type screens 20C and 20D according to the present embodiment and its variant are suitably applicable to an HUD in which an RGB laser is used as the light source 10, for example.

### INDUSTRIAL APPLICABILITY

A transmission-type screen according to an embodiment of the present invention and an HUD including the same can be used for an HUD, a head-mounted display, or other virtual image displays, etc.

### REFERENCE SIGNS LIST

10 video source
20, 20A, 20B, 20C, 20D transmission-type screen
21 first optical element
23 second optical element
22, 24 microlens array (MLA)
25 microlens (ML)
26A, 26B, 29A, 29B lenticular lens
27 cylindrical lens
28 transparent substrate
30 field lens
40 combiner
100 head-up display

1. A transmission-type screen for use in a head-up display, the transmission-type screen having a receiving surface to receive displaying light and an outgoing surface through which to emit a divergent light beam toward a combiner, the transmission-type screen comprising:
a first optical element which is disposed on the receiving surface side and which converges a light beam, the first optical element having a first lens array including a plurality of lenses arranged with lens surfaces thereof being oriented toward the outgoing surface; and
a second optical element which is disposed on the outgoing surface side and which diverges a light beam, the second optical element having a second lens array, wherein,
in the first lens array, a numerical aperture NA of each lens satisfies the relationship NA=(r/2)/[f²+(r/2)²]^{1/2}≤0.13, where r is a diameter of each of the plurality of lenses and f is a focal length of each lens.

2. The transmission-type screen of claim 1, wherein the second lens array is disposed in a position which is at a distance D from the first lens array, the distance D satisfying the relationship D=2 f.

3. The transmission-type screen of claim 1, wherein each of the first and second lens arrays is a microlens array in which a plurality of microlenses are arranged, or a lenticular lens in which a plurality of cylindrical lenses are arranged.

4. The transmission-type screen of claim 1, wherein the first and second lens arrays are microlens arrays in which a plurality of microlenses are arranged.

5. The transmission-type screen of claim 1, wherein the first lens array is a microlens array in which a plurality of microlenses are arranged, and the lens surface of each of the plurality of microlenses has a flat plane in a center of the lens surface, the flat plane being perpendicular to an optical axis.

6. The transmission-type screen of claim 1, wherein the first lens array is a microlens array in which a plurality of microlenses are arranged, and the lens surface of each of the plurality of microlenses has a shape that is characterized by using a negative conic constant.

7. The transmission-type screen of claim 1, wherein the first lens array is a microlens array in which a plurality of microlenses are arranged, the plurality of microlenses being formed as an integral piece, and the microlens array includes a plurality of convex surfaces between two adjacent microlenses, the plurality of convex surfaces being oriented toward the receiving surface.

8. The transmission-type screen of claim 3, wherein the plurality of microlenses of the first optical element are arranged by hexagonal close packing.

9. The transmission-type screen of claim 1, wherein at least one of the first and second lens arrays includes a microlens array in which a plurality of microlenses are arranged, each of the plurality of microlenses having a shape which is a rectangle as viewed from the receiving surface side or the outgoing surface side.

10. The transmission-type screen of claim 1, wherein the second optical element includes a first lenticular lens having a plurality of cylindrical lenses arranged along a first direction and a second lenticular lens having a plurality of cylindrical lenses arranged along a second direction which intersects the first direction.

11. The transmission-type screen of claim 10, wherein a lens surface of the first lenticular lens is oriented toward the receiving surface, and a lens surface of the second lenticular lens is oriented toward the outgoing surface.

12. The transmission-type screen of claim 10, wherein a lens surface of the first lenticular lens is oriented toward the outgoing surface, and a lens surface of the second lenticular lens is oriented toward the receiving surface so as to oppose the lens surface of the first lenticular lens.

13. The transmission-type screen of claim 10, wherein lens surfaces of the first and second lenticular lenses are oriented in a same direction toward the receiving surface or the outgoing surface.

14. The transmission-type screen of claim 10, wherein the first direction and the second direction are orthogonal to each other.

15. The transmission-type screen of claim 10, wherein the first lenticular lens and the second lenticular lens are formed as an integral piece.

16. A head-up display comprising:
a video source to emit displaying light;
the transmission-type screen of claim 1; and
a combiner.

17. The head-up display of claim 16, wherein the video source is a laser light source.
